(19) United States
(12) Patent Application Publication
(10) Pub. No.: US 2012/0048843 A1
(43) Pub. Date: Mar. 1, 2012

(54) ELECTRIC SLOW-STEWING COOKER

(75) Inventors: Minqiang FENG, Foshan (CN); Tianbing GAO, Foshan (CN); Fenglei XING, Foshan (CN)

(73) Assignee: MIDEA GROUP CO., LTD., Foshan (CN)

(21) Appl. No.: 12/973,197

(22) Filed: Dec. 20, 2010

(30) Foreign Application Priority Data
Aug. 31, 2010 (CN) 201020510885.7

(51) Int. Cl. H05B 1/02

(52) U.S. Cl. 219/442

(57) ABSTRACT

The present invention discloses an electric slow-stewing cooker which has three heating modes, namely high-temperature mode, low-temperature mode and keep-warm mode. The electric slow-stewing cooker of the present invention comprises an upper cover, a cooking container, a barrel-like housing, a base, a control panel, heating elements, a control circuit board (PCB) and a manual switch used for controlling the heating elements, and a power supply unit. The heating elements are divided into two portions with one portion being electrically connected to the manual switch to perform the function of the keep-warm mode and the other portion being electrically connected to the control circuit board to perform the function of both the high-temperature mode and the low-temperature mode. At the present invention only one relay switch is required for the electric slow-stewing cooker, which will result in relatively low cost, and the most frequently used keep-warm mode is controlled by a manual switch, which will result in a high reliability.

### FIELD OF THE INVENTION

The present invention relates to an electric slow-stewing cooker. More particularly the present invention relates to an electric slow-stewing cooker which can be controlled both by MCU and by manual switch.

### BACKGROUND OF THE INVENTION

Slow-stewing cooker is a conventional kitchen ware, while electric slow-stewing cooker is a conventional home appliances. E.g. China patent application 200710156463.7 discloses an slow-stewing cooker, which comprises a housing, an aluminum container buckled on the upper chamber inside the housing, a ceramic container embedded inside the aluminum container, a heating circuit slipping over the bottom outside of the aluminum container, a temperature controller for controlling the temperature grade which is electrically connected to the heating circuit, a toggle switch with an indicator locating on the bottom outside of the housing which is electrically connected to the external power supply and the temperature controller. In this patent application, the toggle switch with an indicator is simple in structure with the function of both indicating and operating, and the heating circuit can be quickly installed by making use of elasticity.

China patent application 200510079899.1 discloses temperature controlling slow-stewing cooker for keeping nutrition and its method for accurately auto-controlling temperature. The slow-stewing cooker of the above patent application comprises a pan unit, a porcelain container located in the pan unit, a controlling circuit board for the pan unit, a sensor for the porcelain container, a Single-Chip Microcomputer, and an automatic switch. The method for automatically controlling temperature in the above patent application comprises: A) high temperature mode: heating with full power until the sensor temperature reaches T1, then heating with low power until the temperature reaches T2 and heating with full power again when the temperature falls to T3 to maintain the sensor temperature between T2 and T3; B) low temperature mode: heating with full power until the sensor temperature reaches T4, then heating with low power until the temperature reaches T5 and heating with full power again when the temperature falls to T6 to maintain the sensor temperature between T5 and T6; C) keeping-warm mode: heating with full power until the sensor temperature reaches T7 and heating with full power again when the temperature falls to T8 to maintain the sensor temperature between T7 and T8.

U.S. Pat. No. 6,740,855 discloses a programmable slow-cooker appliance, which comprises a heating unit, a heating element, a cooking unit, a non-conductive housing, a lower vent, an upper vent, a programmable circuit and a control panel on the housing. The heating unit includes a bottom and a continuous sidewall extending from the bottom. The bottom and the continuous sidewall, which includes an outer sidewall and an interior sidewall, defines a well-like heating chamber. The heating element is mounted to the heating unit and disposed between the outer sidewall and the interior sidewall. The cooking unit is at least partially received within the well-like chamber. The housing is fixed mounted to the outside of the sidewall of the heating unit and has a bottom wall. The lower vent locates in the bottom wall of the housing for admitting relatively cool air to the housing, and the upper vent locates in the housing for allowing the escape of relatively warm air from the housing. The programmable circuit is positioned within the housing such that heat is convective away as air passes through the housing and the vents, and is electrically connected to the heating element to electronically control and program cooking cycles and temperature. The control panel locates on the housing and is electrically connected to the programmable circuit. A user can sets a time and temperature for cooking item in the programmable slow-cooker appliance of this patent, which is not used solely as a “keep warm” appliance.

In the prior art the heating procedure of a slow-stewing cooker is basically controlled through Micro Controller Unit (MCU) or a chip which control the average power for each mode such as high temperature mode, low temperature mode or keep-warm mode through controlling the on/off of the relay on a power board.

FIG. 1 is a controlling scheme of a slow-stewing cooker in the prior art in which a relay switch controls on/off of circuit for high temperature mode, low temperature mode and keep-warm mode. A slow-stewing cookers with such a design has low cost, because only one relay switch is used. An obvious shortcoming of such a design is that the relay is always in its working state and thus becomes fatigue relatively easily, which may decrease its life.

To overcome the shortcoming of the above design, a scheme of controlling circuit showed in FIG. 2 has been adopted in an electric slow-stewing cooker in the prior art. It uses two relays and two heating elements in which one of the two relays and one of the two heating elements are shared for both high temperature mode and low temperature mode, and the other relay and the other heating element are used solely for keep-warm mode because this relay used in keep-warm mode is more frequent in its working state than the other one, and becomes fatigue more easily. Compared with an electric slow-stewing cooker with a scheme showed in FIG. 1, an electric slow-stewing cooker with a scheme showed in FIG. 2 is more reliable. However, using two relays would result in high cost.

Therefore, it is necessary to provide an electric slow-stewing cooker with both low cost and high reliability.

### SUMMARY OF THE INVENTION

The object of the present invention is to provide an electric slow-stewing cooker which has high reliability and low cost.

To fulfill the above object the present invention makes use of a new controlling concept for its controlling circuit. Considering the keep-warm mode is the most frequently used state for any electric slow-cooler appliance a separate heating element is assigned to its keep-warm mode in the electric slow-stewing cooker of the present invention. The heating element for the keep-warm mode, which is not controlled by MCU, is directly connected to a power cord via its own manual switch such as a toggle switch. In the present invention another heating element is assigned to the high-temperature mode and low-temperature mode, which is controlled by a relay switch under the controlling of a control circuit board (PCB). With such a design only one relay switch is needed in the present invention, which will result in relatively low cost, and the most frequently used keep-warm mode is controlled by a manual switch, which will result in a high reliability.

The electric slow-stewing cooker of the present invention has three heating modes, namely the high-temperature mode, the low-temperature mode and the keep-warm mode, comprising an upper cover, a cooking container, a barrel-like housing, a base, a control panel, heating elements such as heating tape or heating cord, a control circuit board (PCB) and a manual switch such as a toggle switch used for controlling the heating elements, and a power supply unit. The upper cover is matched with and is used to cover the opening of the cooking container. The cooking container defines a hollow space for processing food items and is received within the housing. The shape of the base is matched with the bottom of the housing. The control panel is mounted on the housing. The heating elements are located between the cooking container and the housing, which are divided into two portions with one portion being connected to a power cord via the manual switch to perform the function of the keep-warm mode and the other portion being electrically connected to the PCB to perform the function of both the high-temperature mode and the low-temperature mode.

The upper cover is preferably made from a transparent material such as glass in order to watch the processed food item according to the electric slow-stewing cooker of the present invention. The housing can be made from metal, non-conductive synthetic material or other suitable material.

Preferably the cooking container in the present invention includes an inner container and an outer container with the inner container being located within the outer container in order to reach the effect of keeping warm and cooking slowly. Accordingly the heating elements can be positioned between the outer container and the housing, preferably attached closely to the sidewall and/or the bottom of the outer container.

In an preferable embodiment the inner container can be a pottery container and the outer container can be a metal container according to the electric slow-stewing cooker of the present invention. The pottery inner container can be used to reach a special cooking effect while the metal outer container can increase its strength to prevent it from being damaged when impact occurs during usage.

In a further preferable embodiment the pottery inner container and the metal outer container are not contacted with each other on their bottoms and on at least part of their sidewalls according to the electric slow-stewing cooker of the present invention. That means there exists gap between their bottoms and between at least part of their sidewalls in order to reach the slow stewing effect via the air in the gap.

According to the electric slow-stewing cooker of the present invention the power supply unit includes a power pack and a power circuit board, which can be positioned under the base or on the bottom surface of the base to save space.

The electric slow-stewing cooker of the present invention can further include an overlay and an underlay for the power cord. The power cord overlay and the power cord underlay can also be positioned on the bottom surface of the base.

The electric slow-stewing cooker of the present invention can further include a maneuver box between the control panel and the housing, which further includes an upper part and a lower part. The PCB used for controlling the heating elements can be located within this maneuver box.

The electric slow-stewing cooker of the present invention adopts new electrical structure with the PCB being used only to control the high/low-temperature modes and the keep-warm mode not being controlled by the PCB. The keep-warm mode has its own heating element which is directly connected to the power cord. Thus the electric slow-stewing cooker of the present invention can satisfy the requirements of the high-temperature mode, the low-temperature mode and the keep-warm mode with only one relay switch being needed. Such a design will result in relatively low cost and a high reliability because the most frequently used keep-warm mode is controlled by a manual switch.

All the above and other characteristics and advantages of the invention will be further understood through the following illustrative and non-limitative description of preferred embodiments thereof, with reference to the appended drawings. In the drawings the same numerals are sometimes used to indicate the same elements in different drawings.

### BRIEF DESCRIPTION OF THE DRAWINGS

FIG. 1 shows one controlling scheme for heating in an electric slow-stewing cooker in the prior art.

FIG. 2 shows another controlling scheme for heating in an electric slow-stewing cooker in the prior art.

FIG. 3 shows the controlling scheme for heating in an electric slow-stewing cooker according to one embodiment of the present invention.

FIG. 4 is a perspective view of an electric slow-stewing cooker according to one embodiment of the present invention.

FIG. 5 is the top view of the electric slow-stewing cooker showed in FIG. 4.

FIG. 6 is a section view of an electric slow-stewing cooker according to one embodiment of the present invention.

FIG. 7 is another section view of the electric slow-stewing cooker showed in FIG. 6 with its section plane perpendicular to that of FIG. 6.

FIG. 8 is an explosive view of an electric slow-stewing cooker according to one embodiment of the present invention.

In the above drawings the reference numbers represent namely: 1 handle, 2 handle guide, 3 glass upper cover, 4 pottery inner container, 5 metal outer container, 6 metal housing, 7 upper part of maneuver box, 8 digitron cover, 9 controlling circuit board (PCB), 10 lower part of maneuver box, 11 base, 12 power pack on the base, 13 power circuit board, 14 overlay of power cord, 15 underlay of power cord, 16 heating elements (heating tape or heating coils), 17 side handle, 18 screw spacer on upper cover, 19 rubber feet, 20 phillips truss head screw (cruciform slot truss head screw), 22 screw for upper cover, 23 screw, 24 phillips truss head screw, 25 control panel, and 26 toggle switch.

### DETAILED DESCRIPTION OF PREFERRED EMBODIMENTS

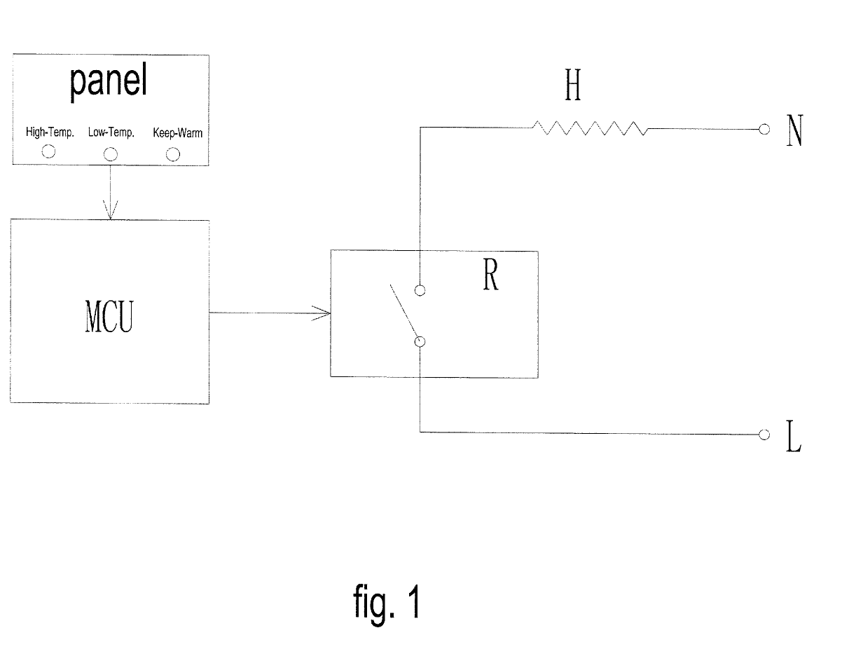

FIG. 1 shows one controlling scheme for heating in an electric slow-stewing cooker in the prior art. Such an electric slow-stewing cooker includes one heating element (H) and one relay switch (R), in which the relay switch controls electrical connection for high-temperature mode, low-temperature mode, and keep-warm mode. The disadvantage of such a design is that the relay switch is always in a work state.

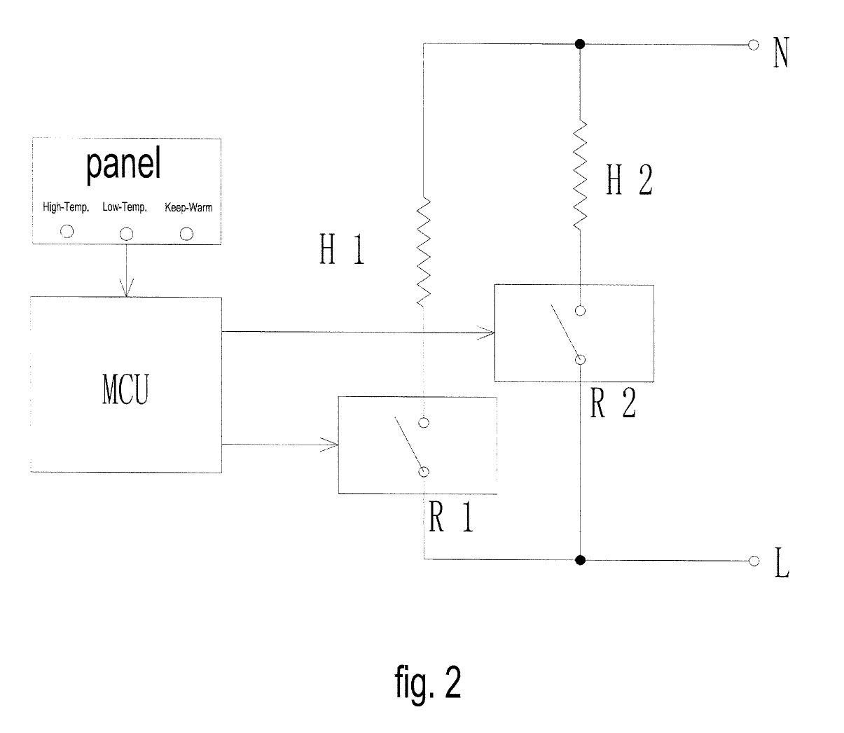

FIG. 2 shows another controlling scheme for heating in an electric slow-stewing cooker in the prior art with two relay switches (R1 and R2) and two heating elements (H1 and H2). The disadvantage of such a design is a relatively high cost.

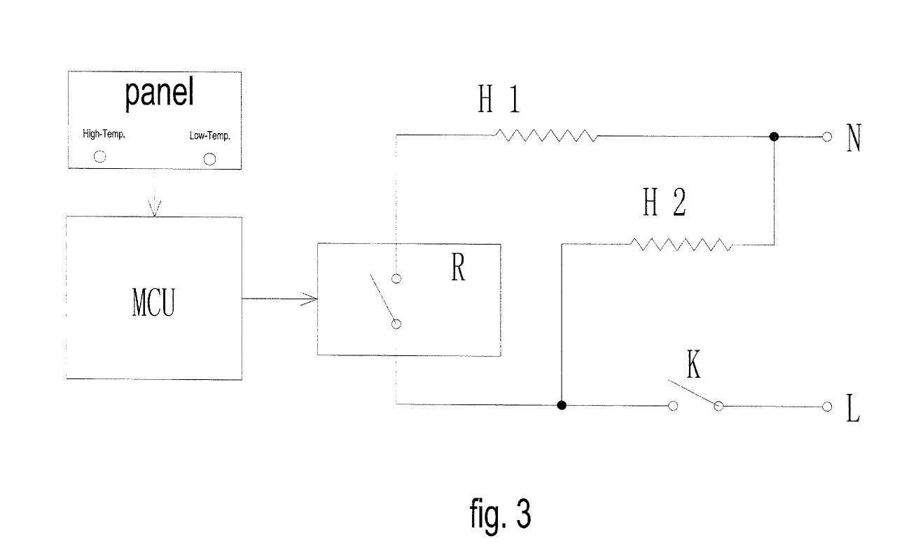

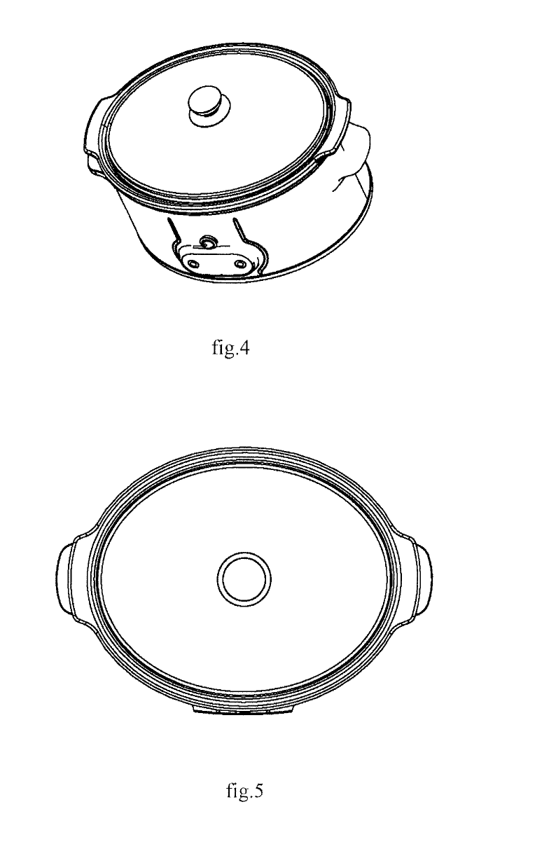

FIG. 3 shows the controlling scheme for heating in an electric slow-stewing cooker according to one embodiment of the present invention in which one relay switch (R) is used to control two heating elements (H1 and H2). FIG. 4 is a perspective view of an electric slow-stewing cooker according to one embodiment of the present invention. FIG. 5 is the top view of the electric slow-stewing cooker showed in FIG. 4.

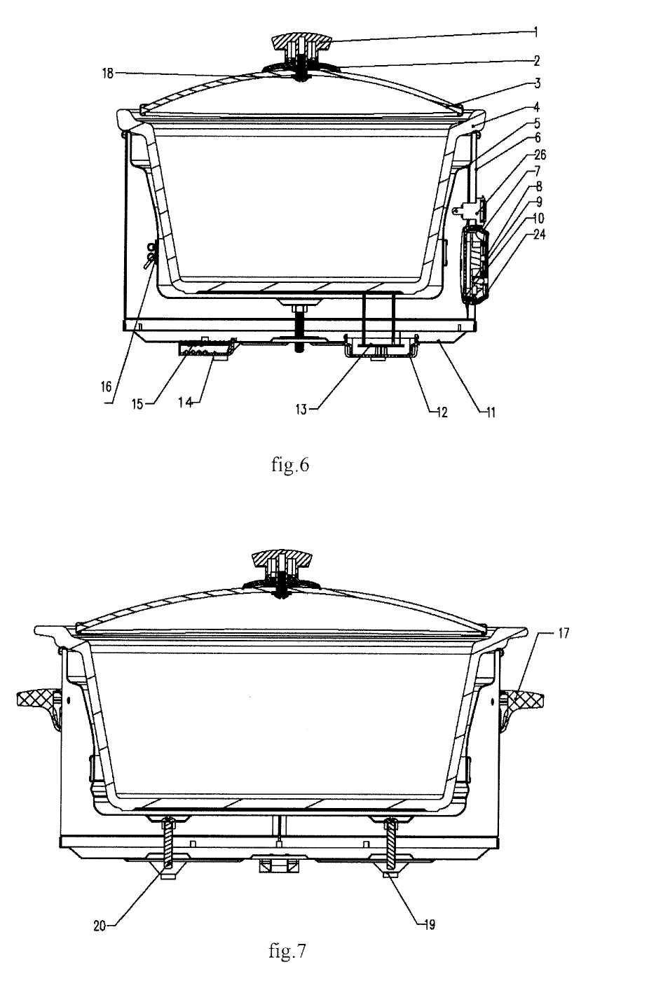

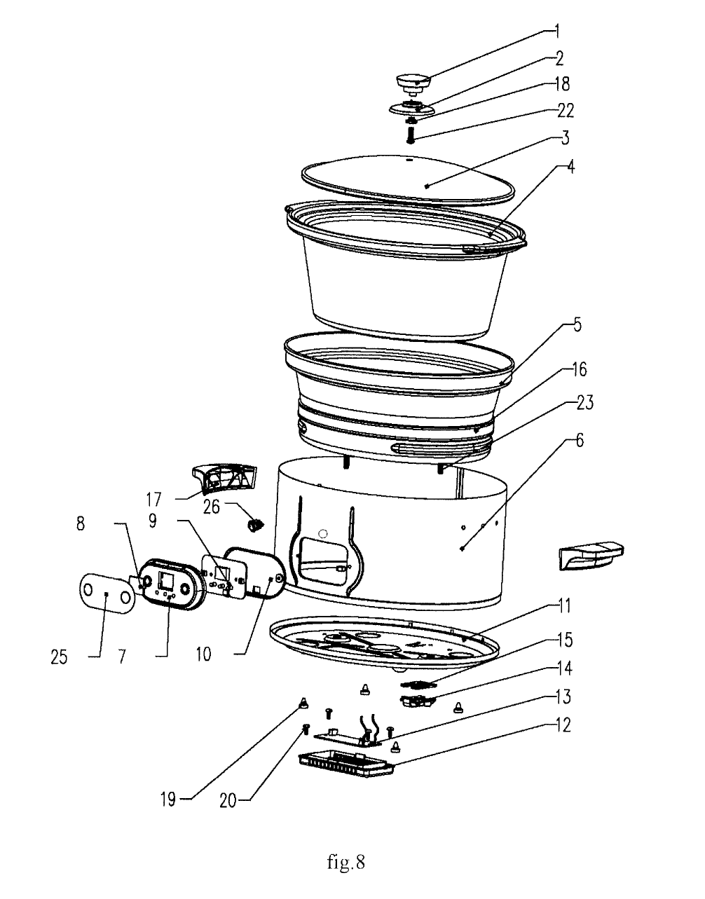

As shown in FIGS. 6-8, an electric slow-stewing cooker according to one embodiment of the present invention comprises an glass upper cover 3, a cooking container, a barrel-like metal housing 6, a base 11, a control panel 25, heating elements 16, a controlling circuit board 9 and a toggle switch 26 used for controlling the heating elements 16, and a power supply unit. The glass upper cover 3 is matched with and can cover the opening of the cooking container. The cooking container defines a hollow space for processing food items and is received within the metal housing 6. The shape of the base 11 is matched with the bottom of the metal housing 6. The control panel 25 is mounted on the metal housing 6 via phillips truss head screws 24. The heating elements 16 are attached closely to the sidewall of the container.

The heating elements 16 is a heating tape which is attached closely to the outside sidewall of the cooking container through a spring (not shown in Figs.). The outside sidewall of the cooking container has raised portion below the heating tape to prevent it from falling off. The heating tape has a first heating resistor H1 and a second heating resistor H2, which are independent on each other. The second heating resistor and a toggle switch K are connected to the power in series. The heating state of the second heating resistor is controlled by the action of the toggle switch K to keep the keep-warm mode. The first heating resistor is connected with a relay switch R in series, then they are connected with the second heating resistor in parallel. The heating state of the first heating resistor is controlled by a controller MCU to perform the function of both the high-temperature mode and the low-temperature mode.

The specific procedure can be as follows:

Manually close the toggle switch K. Then the second heating resistor starts to heat. Select a desire heating mode by selecting the high-temperature switch or the low-temperature switch on the control panel. The controller MCU controls the on/off of the relay according to the programs set up for different heating modes based on received signal for heating modes, and thus controls the heating state of the first heating resistor. The different duty cycle for the ration of on-time to off-time of the relay will result in different average heating intensity of the first heating resistor.

When heated in the high-temperature mode the duty cycle of the on-time of the relay is relatively bigger and accordingly the average heating intensity is bigger with a faster heating speed. The food item in the cooking container can be quickly heated to its boiling state. When heated in low-temperature mode the duty cycle of the on-time of the relay is relatively smaller and accordingly the average heating intensity is smaller with a slower heating speed. The food item in the cooking container will need more time to be heated to its boiling state. Here the duty cycle equals the working time divided by the sum of the working time plus the non-working time.

When proceeded to the end set by the programs for different heating modes the controller MCU will keep the relay in its off state and the first heating resistor stops heating. At that time only the second heating resistor keep working to maintain the keep-warm state, the heating mode will automatically turn to the keep-warm mode.

The glass upper cover 3 has a handle 1. Via a handle guide 2, screw spacers 18 and screws 22 the handle 1 can be fixed onto the glass upper cover 3. The glass upper cover can also have vents for escaping air.

The cooking container can consist of an inner container 4 and a metal outer container. The inner container 4 and the metal outer container 5 are not contacted with each other on their bottoms and on at least part of their sidewalls. That means there exists gap between their bottoms and between at least part of their sidewalls. The inner container 4 can be made from pottery material or from metal material.

The metal housing 6 can have two symmetrical side handles 17. A maneuver box comprising an upper part 7 and a lower part 10 can be positioned between the control panel 25 and the metal housing 6, in which the control circuit board 9 for controlling the first heating resistor of the heating elements 16 is located within this maneuver box. A toggle switch 26 is located above the control panel to make the second heating resistor of the heating elements directly be connected to the power cord. A digitron cover 8 is located between the control panel 25 and the upper part 7 of the maneuver box.

A power pack 12 and a power circuit board 13 are mounted below the base 11 or on the bottom surface of the base 11. There are further an overlay 14 of the power cord and an underlay 15 of the power cord on the bottom surface of the base 11.

The metal outer cooking container 5, the metal housing 6 and the base 11 are fixed as a whole through phillips truss head screws 20 and screws 22. Rubber feet 19 can be a support for supporting the electric slow-stewing cooker of the present invention on a table.

The heating elements 16 can also be a heating cord which can be stick to the outside of the sidewall of the cooking container with aluminum foil. The heating cord can have a first heating cord and a second heating cord which are independent on each other.

The heating elements 16 can also be two independent heating tapes, two independent heating cords, or one heating tape plus one heating cord. Each heating tape or heating cord has a heating resistor.

Although embodiments of the invention have been described by way of illustration, it will be understood that the invention may be carried out with many variations, modifications, and adaptations, without exceeding the scope of the claims.

What is claimed is:

1. An electric slow-stewing cooker which can be performed in high-temperature mode, low-temperature mode and/or keep-warm mode, said electric slow-stewing cooker comprises an upper cover, a cooking container, a barrel-like housing, a base, a control panel, heating elements, a control circuit board and a manual switch which are used for controlling said heating elements, and a power supply unit,
wherein the upper cover is matched with and is used to cover the opening of the cooking container, the cooking container defines a hollow space for processing food items and is received within the housing, the shape of the base is matched with the bottom of the housing, the control panel is mounted on the housing, and the heating elements are located between the cooking container and the housing,
wherein the heating elements are divided into two portions with one portion being electrically connected to the manual switch to perform the function of the keep-warm mode and the other portion being electrically connected to the control circuit board to perform the function of both the high-temperature mode and the low-temperature mode.

2. The electric slow-stewing cooker according to claim 1, wherein said cooking container includes an inner container and an outer container, and said heating elements is positioned between said outer container and said housing.

3. The electric slow-stewing cooker according to claim 2, wherein said inner container is a pottery container, and said outer container is a metal container.

4. The electric slow-stewing cooker according to claim 3, wherein said pottery inner container and said metal outer container are not contacted with each other on their bottoms and on at least part of their sidewalls.

5. The electric slow-stewing cooker according to claim 1, wherein said power supply unit includes a power pack and a power circuit board, and said power pack and said power circuit board are positioned under said base or on the bottom surface of said base.

6. The electric slow-stewing cooker according to claim 5, wherein said electric slow-stewing cooker further includes an overlay and an underlay for said power cord, and said overlay and said underlay is positioned on the bottom surface of said base.

7. The electric slow-stewing cooker according to claim 5, wherein said electric slow-stewing cooker further includes a maneuver box between said control panel and said housing.

8. The electric slow-stewing cooker according to claim 7, wherein said maneuver box further includes an upper part and a lower part.

9. The electric slow-stewing cooker according to claim 7, wherein said control circuit board for controlling said heating elements is located within said maneuver box.
